(19) United States
(12) Patent Application Publication
(10) Pub. No.: US 2005/0037252 A1
(43) Pub. Date: Feb. 17, 2005

(54) Tubular solid oxide fuel cells

(76) Inventor: Ai Quoc Pham, San Jose, CA (US)

Correspondence Address: MACPHERSON KWOK CHEN & HEID LLP, 1762 TECHNOLOGY DRIVE, SUITE 226, SAN JOSE, CA, 95110, US

(21) Appl. No.: 10/912,783

(22) Filed: Aug. 6, 2004

Related U.S. Application Data
(60) Provisional application No. 60/494,379, filed on Aug. 11, 2003.

(51) Int. Cl. H01M 8/10

(52) U.S. Cl. 429/31; 429/32

(57) ABSTRACT

An anode-supported tubular fuel cell stack includes interconnect structures that are oxidation resistant at high temperature, flexible to accommodate thermal expansion stress and to provide strong electrical contact, have low electrical resistance, and are inexpensive and light weight. The interconnect structures may be formed out of metal sheet, which provide improved heat homogeneity throughout the fuel cell stack because of the high thermal conductivity of the metal. The interconnect structures are further shaped to provide resilience or spring-like features to allow movement between the tubular cells. Thus good electrical contact, thermal stress release, and shock absorption are simultaneously achieved.

### CROSS-REFERENCE TO RELATED APPLICATIONS

This application claims priority of U.S. Provisional Patent Application No. 60/494,379, entiled “Tubular Solid Oxide Fuel Cells”, filed on Aug. 6, 2003.

### BACKGROUND OF THE INVENTION

1. Field of the Invention

The present invention relates to solid electrolyte electrochemical cells; more particularly, the present invention relates to anode-supported tubular electrochemical cells and methods for electrically connecting such electrochemical cells in various configurations to provide various voltages and currents required by many applications.

2. Discussion of the Related Art

Fuel cells are electrochemical devices that convert chemical fuels directly into electricity without combustion. A fuel cell typically includes an electrolyte membrane sandwiched between two electrodes: a cathode in contact with a source of air (“air electrode”) and an anode in contact with the chemical fuels (“fuel electrode”). Among the various known types of fuel cells, the solid oxide fuel cell (SOFC) is highly efficient, and thus is suitable for stationary power generation and transportation applications. An SOFC also discharges few pollutants.

Fuel cells may have a structure that derives mechanical support from either an electrolyte layer or from one of the electrodes. In an electrolyte-supported fuel cell, an electrolyte layer (e.g., stabilized zirconia), which acts as a membrane permeable to oxygen ions at high temperature, provides the mechanical support for the fuel cell. Such an electrolyte layer is typically required to be 100 μm or more thick. The fuel electrode and the air electrode are then deposited as thin films on the two sides of the electrolyte layer. One disadvantage of an electrolyte-supported fuel cell is the low power output because of the large ohmic resistance of the thick electrolyte layer. To reduce the ohmic resistance, an electrolyte-supported cell typically operates at very high temperatures (e.g., 900° C. or above).

Comparatively, an electrode-supported cell has a significantly higher power output even at a lower operating temperature. In an electrode-supported cell, a thick electrode provides the mechanical support, so that the electrolyte layer may be provided to be as thin as 20 μm or less. An anode-supported cell may attain a power density greater than 1 W/cm² at 800° C., thus significantly exceeding the typical power density of about 0.3 W/cm² attained in an electrolyte-supported cell. A cathode-supported fuel cell typically has a lower power density than an anode-supported fuel cell, and may have side reactions between the cathode and the electrolyte materials. The cathode, which may be made from doped lanthanum manganite, is mechanically weaker, but more expensive, than the anode, which may be made of ceramic metallic composite of nickel and stabilized zirconia.

Because each single cell can provide only a voltage of 1 volt or less, many cells are typically connected in series and in parallel to generate usable voltage and current levels. Typically, SOFCs are organized in different configurations (“stacks”) to deliver the required voltages and currents. Among existing configurations, the major designs of interests are planar and tubular. Detail descriptions of various configurations may be found in “Ceramic Fuel Cells,” by Minh, in the Journal of the American Ceramic Society, vol. 76, pp.563 et seq. (1993).

FIG. 1 shows schematically planar solid oxide fuel cell 100 in the prior art. As shown in FIG. 1, planar solid oxide fuel cell 100 includes anode 102 (the fuel electrode), cathode 104 (the air electrode), and a solid electrolyte layer provided between the two electrodes. For an electrolyte-supported cell, the electrolyte layer may have a thickness between 80 to several hundreds microns, while the two electrodes are typically less than 40 microns thick. For an electrode-supported cell, the electrode which provides mechanical support is the thickest component, while the electrolyte layer and the other electrode may be made substantially thinner. The anode-supported configuration is generally the preferred configuration because of the strong mechanical integrity resulting from cermet (ceramic-metallic composite of nickel and yttria-stabilized zirconia (YSZ)), and a high electrochemical performance. Each planar fuel cell is typically sandwiched between two interconnect plates that carry the generated electricity.

A number of fuel cells, each having the structure of planar fuel cell 100, may be stacked to provide a high power capacity. A conductive bipolar interconnect plate 108 connects in series adjacent cells, by physically contacting the cathode of one cell on one side of the plate and the anode of another cell on the other side, while also providing gas channels for both air and fuel flows. Interconnect plate 108 allows the current generated in the cells to flow between cells and be collected. These interconnect plates are formed into manifolds through which air and fuel may be supplied to the respective electrodes. To avoid undesirable mixing and reacting between the fuel and air, the interconnect plates are sealed at the edges of the planar cell.

The interconnect plate is typically made using a ceramic, such as lanthanum chromite, or a high temperature oxidation resistant alloy. A ceramic plate is typically expensive, brittle and difficult to machine. A metallic interconnect plate, however, loses conductivity because of metal oxidation at high temperature. Using high-performance anode-supported cells, the metallic interconnect structure may support operation at a temperature in the intermediate range of 500° C. to 800° C. (i.e., reduced from 1000° C. typical of SOFCs using ceramic plates).

Metallic interconnect plates in planar fuel cells experience high mechanical stress induced by the mismatch between the low expansion ceramic and the high expansion alloys, and the oxidation and corrosion of the alloys in air and fuel environments. The flat ceramic plates, which are typically thinner than 1 mm while having an aspect ratio greater than 100, tend to fracture easily. In a planar fuel cell stack, the extensive sealing area and the absence of an effective seal are major technical issues. Planar fuel cells require high temperature seals and must endure a higher mechanical stress resulting from the mismatched thermal expansion coefficients of the brittle ceramic fuel cells and the interconnect components. The difference in thermal expansions between the ceramic fuel cell components and the metallic interconnects during thermal cycles also contributes to fracture and seal leaks.

A tubular fuel cell, which is mechanically stronger than a planar fuel cell of comparable dimensions, requires a seal only around the circumference of the tube at one end. This is because the other end of the tube may be closed, and the curved surface along the length of the tube acts as its own seal. A cathode-supported tubular fuel cell has a high fabrication cost because of the expensive cathode material and the complex fabrication technique (e.g., chemical vapor deposition) necessary to provide an electrolyte layer of up to 40 μm thick.

FIG. 2 shows a side view and a cross-section view of a prior art on tubular cathode-supported SOFC. As shown in FIG. 2, cathode or air electrode 202 may be formed as an interior tube from ceramic materials, such as lanthanum manganite. In FIG. 2, cathode 202 is formed over a porous support tube, which may be formed from an insulating material. Cathode 202 is shown coated with solid electrolyte (layer 204) for most of its curved surface, except for an area underneath interconnect structure 208 shown in FIG. 2 as a narrow stripe along the length of the cathode. Electrolyte layer 202 is coated with the material for anode or fuel electrode 206. During operation, air¹ is pumped into the interior tube from one end of the tube, while the fuel gas is flown outside of the tube. As the other end of the tube of the fuel cell is closed, the injected air flows back to the open end in the annular space between the anode and the support tube. Because of the long current paths, a cathode-supported tubular fuel cell provides a low output of less than 0.3 W/cm², even at 1000° C.
¹ Throughout this detailed description, the term “air” is used to mean any oxygen bearing gas.

Interconnect structure 208 is a dense but electrically conductive material (e.g., doped-lanthanum chromite) deposited on the portion of cathode 202 that is not covered by electrolyte layer 204. The dense material in interconnect structure 208, which isolates the air from the fuel compartments and provides a contact point for drawing a current from cathode 202, is required to be stable in both air and fuel environments.

Anode 206 is typically formed on the outside surface of the electrolyte layer by slurry dipping. FIG. 3 shows a portion of a prior art fuel cell stack having multiple tubular SOFCs (e.g., tubular fuel cell 200 of FIG. 2) electrically interconnected in series and parallel configurations. As shown in FIG. 3, a nickel felt, typically nickel fibers, is inserted between adjacent tubes and acts as the interconnect. The flexible felt enhances electrical contact between the tubes that may have imperfections in tube straightness and surface flatness, and release possible stresses developed in the stacking of the tubes. Nickel felt is an expensive material.

Beside nickel felts provided over the thin stripe, as shown in FIG. 2, there are many variations in the electrical connection to the tubes. U.S. Pat. No. 6,416,897 to Tomlins et al. teaches using a nickel mesh that is rolled to form a porous, hollow metal conductor. U.S. Pat. No. 6,379,831 to Draper et al. teaches using an expanded nickel mesh corrugated into crown portions and shoulder portions and disposed across a complete layer of fuel cell tubes. Such a design potentially could eliminate the need for individual contact between two adjacent tubes in the same row for parallel connection. U.S. Pat. No. 5,258,240 to Di Croce et al. teaches using a thick, flat-backed, porous metal fiber felt connector strip, having a crown portion of metallic fiber felt conforming to the surface of the contacting fuel cell. These porous felt connectors could be used as a porous foil extending along the entire axial length of the fuel cells.

The tubular cathode-supported fuel cell generally requires expensive vacuum fabrication techniques to deposit the electrolyte layer on the cathode. The inexpensive slurry coating technique is not applicable due to undesirable reactions between the cathode and the electrolyte layer during high temperature sintering. Furthermore, the cathode-supported tubular design suffers from high ohmic losses due to long current path along the circumference of the cathode tube. As can be seen in FIG. 3, the current coming from all around the tube is collected at the interconnect structure 208. Thus, the maximum current path is about half the circumference of the tube, which may be as far as centimeters as opposed to microns in the case of planar fuel cell. As a result, the cathode-supported tubular fuel cell has much lower power density than the planar fuel cells (e.g., a typical power density is less than 300 mW/cm² at 1000° C., while that of planar anode-supported cells can be higher than 1000 mW/cm² at several hundred degrees lower).

Anode-supported tubular fuel cells may be fabricated using a conventional ceramic processing technique because there is no undesirable reaction between the anode and the electrolyte material. U.S. Pat. No. 6,436,565 and U.S. patent application 20020028367 describe fabrications of a tubular fuel cell using ceramic extrusion or a similar technique. The anode-supported fuel cell also has a higher power density and operates at a lower operating temperature than a comparable cathode-supported fuel cell. A tubular SOFC that is anode-supported is proposed in U.S. Pat. No. 4,490,444 to Isenberg.

The electrical connections among anode-supported fuel cells are more difficult. In the anode-supported structure, the electrical connectors are required to be both oxidation resistant in the airflow at high temperatures and flexible to maintain good electrical contacts with the tubular cells over the thermal cycles through low and high temperatures. The nickel metal felt which are used as electrical connectors in cathode-supported fuel cells are not used in anode-supported fuel cells because nickel oxidizes in air to form a low conductivity nickel oxide. The aforementioned U.S. Pat. No. 4,490,444 suggests using indium oxide fiber in anode-supported fuel cells to eliminate the high temperature oxidation damage. Indium oxide, however, is an expensive material and a reliable technique for fabricating flexible indium oxide fibers or felts has yet to be demonstrated. U.S. Pat. No. 6,436,565 to Song et al. teaches the use of a doped lanthanum manganite paste as an electrical connector for parallel connection of anode-supported cells. This design circumvents the issue of nickel mesh oxidation, but creates mechanical problems associated with the lack of flexibility of the ceramic lanthanum manganite. This design also creates a parallel electrical connection between all the tubes, and thus a very high current would be generated even at very low voltage, so that only limited currents can be drawn from the system. Such a design is not scalable for high power applications (e.g., multiple kilowatts).

U.S. Pat. No. 5,827,620 to Kendall describes using metallic wires as electrical connectors wrapped around the tubular cells between tubular cells. (See also PCT patent publication WO02099917 by Tomsett et al.) This design is inefficient because of the long current paths along the wires, so that only limited currents can be provided without excessive resistive loss. Furthermore, if the tubes are connected in series, a failure in one fuel cell may cause the failure of the entire stack.

Thus the tubular anode-supported structure fuel cells have potentials to have high performance in power density, mechanical and structural strength. The interconnect structure, however, remains a barrier to creating a reliable and high power fuel cell stack. An interconnect component is desired that is oxidation-resistant at high temperature, low electrical resistance, inexpensive, light weight and flexible enough to accommodate thermal expansion stress and to provide strong electrical contact.

### SUMMARY OF THE INVENTION

According to one embodiment of the present invention, an anode-supported tubular fuel cell stack is provided having interconnect components that are oxidation-resistant at high temperatures, flexible enough both to accommodate thermal expansion stress and to provide strong electrical contact, low electrical resistance, inexpensive and lightweight. The tubular fuel cell design provides mechanical strength for high power applications. Such an anode-supported structure provides a higher power density than comparable cathode-supported or electrolyte-supported fuel cells.

A metal interconnect component of the present invention may be formed out of, for example, a perforated metal sheet that is resistant to high temperature oxidation. The metal interconnect component may have one of many shapes achieved by folding, stamping or bending the metal sheet. Because of the high conductivity of metal, the metal interconnect components improves the heat homogeneity throughout the fuel cell stack. The metal interconnect components formed out of sheet metal may have flexible contact surfaces to conform to the surfaces of the tubular cells, and may be used to make parallel and series electrical connections among the tubular cells. The flexible contact surfaces provide good electrical contact and release thermal stresses, while increasing the ability to resist vibrations and shocks of the cell stack. The metal interconnect components may have a curved section which conforms to the outer curved surface of a tubular cell. The curved surfaces hold the tubular cells in place and provide maximum contact areas with the fuel cell electrodes, thereby reducing the electrical resistance loss of the stack.

The present invention also provides a tubular fuel cell that carries out indirect internal fuel reforming in the presence of a catalyst, with good heat exchange between fuel reforming and electrochemical oxidation.

The present invention is better understood upon consideration of the detailed description below and the accompanying drawings.

### BRIEF DESCRIPTION OF THE DRAWINGS

FIG. 1 shows schematically a planar solid oxide fuel cell in the prior art.

FIG. 2 shows a side view and a cross-section view of a prior art on tubular cathode-supported SOFC.

FIG. 3 shows a portion of a prior art fuel cell stack having multiple tubular SOFCs electrically interconnected in series and parallel configurations.

FIG. 4 shows an anode-supported SOFC 400, in accordance with one embodiment of the present invention.

FIG. 5 shows a cross-section view of a folded sheet metal interconnect element connecting two tubular fuel cells, in accordance with one embodiment of the present invention.

FIG. 6a, b, and c show the structures of metal sheet interconnect elements 601, 602 and 603, respectively, formed out of folding a metal sheet, in accordance with embodiments of the present invention.

FIG. 7 shows tubular fuel cell stack 700 in which sheet metal interconnect elements interconnect the fuel cells of the fuel cell stack in series, according to one embodiment of the present invention.

FIG. 8 shows tubular fuel cell stack 800, having metal sheets 801 and 802, and sheet metal interconnect elements that interconnect the fuel cells of fuel cell stack 800 both in series and in parallel, according to one embodiment of the present invention.

FIG. 9 shows interconnect structures 901 and 902, each formed in the shape of a metal bar and having semi-circular grooves to accommodate the tubular fuel cells and thin grooves in a perpendicular direction to allow fuel or air passage.

FIG. 10(a) shows interconnect structures 1001 and 1002, which may be formed out of a high temperature oxidation resistant metal sheet, according to one embodiment of the present invention; structures 1001 and 1002 each include flat portions, which provide structural support, and semi-circular groove portions to hold the tubular cells in place.

FIG. 10(b) shows interconnect structure 1001 in greater detail along a cross section.

FIG. 11 shows metal sheet interconnect structures 1101 for a tubular fuel cell stack, according to another embodiment of the present invention; interconnect structure 1101 is formed out of a single sheet metal to include bent portion 1102, which provides resilience or spring-like action to allow lateral movements of the tubular cells, and a curved portion 1103, which allows two-dimensional electrical connect with the cathodes of all the tubular cells in one row.

FIG. 12 shows interconnect structure 1201, which includes a flat portion 1203 and a number of curved portions 1204 each having curved fingers, in accordance with one embodiment of the present invention.

FIG. 13 shows interconnect structure 1301, in accordance with another embodiment of the present invention; interconnect structure 1301 includes multiple “U” shape bent portions 1302, each having inward tilting prongs of the “U” shape, and a wide flat bottom.

FIG. 14 shows interconnect structures 1401 and 1402, which may be formed out of a high temperature oxidation resistant metal sheet, similar to interconnect structures 1001 and 1002 of FIG. 10(a); perforations in each of interconnect structures 1401 and 1402 may be formed by stamping, with the stamped out sheet metal formed into bent fingers extending below the semi-circular groove portions.

FIG. 15 shows one method for delivering fuel gas to each anode-supported fuel cell using fuel delivery tube 1501.

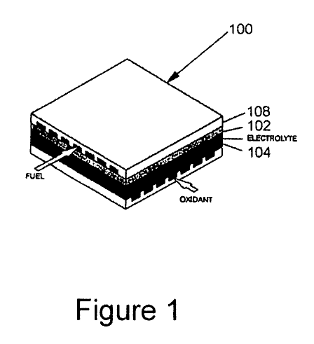

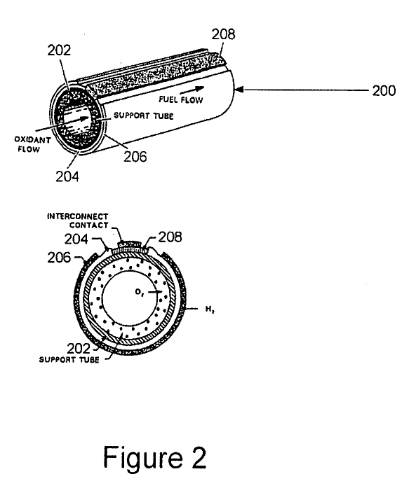

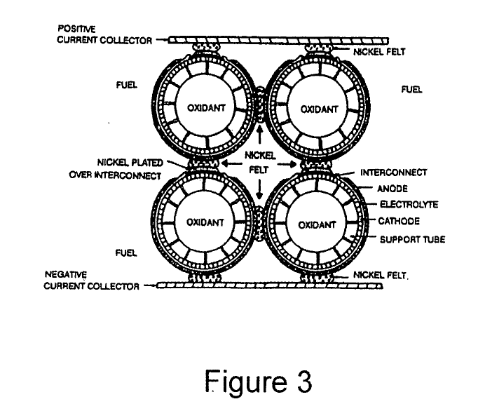

### DETAILED DESCRIPTION OF THE PREFERRED EMBODIMENTS

The present invention provides a tubular anode-supported fuel cell that has a higher power density and enhanced mechanical strength over a prior art planar fuel cell. The present invention further provides a flexible, lightweight, and economical electrical interconnect components for interconnecting anode-supported fuel cell.

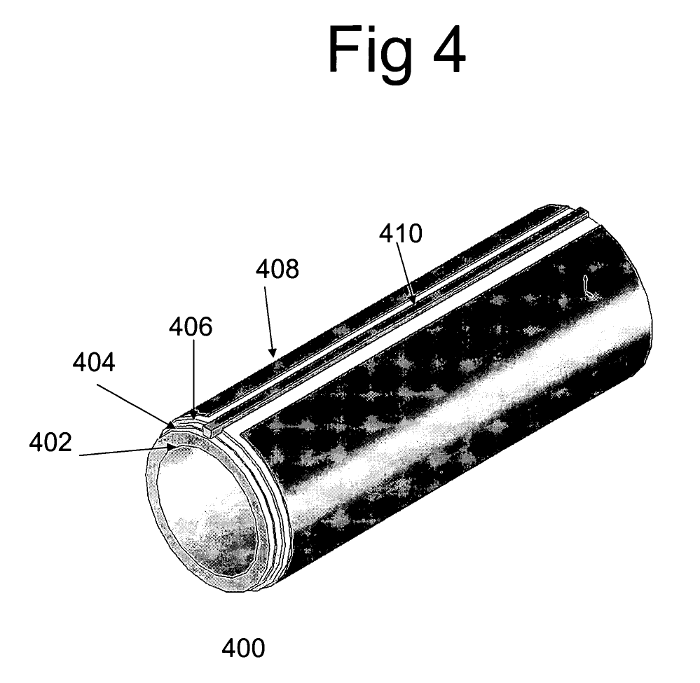

FIG. 4 shows an anode-supported SOFC 400, in accordance with one embodiment of the present invention. As shown in FIG. 4, SOFC 400 includes porous support tube 402, which may be between 0.1 to 4 mm thick (more preferably between 0.5 to 2 mm thick) and between ¼ inch to 1 inch in diameter (preferably between ¼ to 3/4 inch). A smaller diameter shortens the current path and thus reduces ohmic resistance loss. Support tube 402 may be made from a wide variety of materials, including alumina, doped-zirconia, doped lanthanum chromite. To minimize the ohmic loss due to electrical conduction along the circumference of the tube, the tube material is preferably electrically conductive (e.g., composite materials of alumina, doped-zirconia with a conductive metallic phase, such as nickel, or a high temperature alloys, such as Inconnel 600). The conductive materials can also be another conductive ceramic such as oxide, carbide or nitride.

Active porous anode layer 404, such as a composite of nickel and a yttria-stabilized zirconia (YSZ), is then deposited over the entire outer surface of support tube 402 to a thickness of the anode layer between 20 to 100 microns (more preferably between 20 to 75 microns). Thin film electrolyte 406 is then coated to a thickness of 1 to 50 microns (more preferably between 5 to 30 microns) to cover most of active anode layer 404, leaving a small width of anode layer 404 exposed along the tube length to provide an electrical contact area to the anode. Electrolyte film 406 can be of any known electrolyte material, or a combination of the electrolyte material, including yttria-stabilized-zirconia or doped-ceria. Cathode or air electrode 408 coats to a thickness between 10 to 100 microns (more preferably between 20 to 50 microns) over most of the electrolyte layer, leaving only the exposed anode contact area not covered. Thin stripe 410 of a dense and electronically conductive material is provided to a thickness between 5 to 100 microns (more preferably between 10 to 50 microns) to cover the exposed anode contact area. Suitable materials for the dense, electrically conducting thin stripe 410 may be doped-lanthanum chromite or, more generally, a perovskite having a composition of (La,Sr,Ca)(Fe,Mn,Cr,Ti,Nb)O₃. To ensure maximum power generation, electrodes 404 and 408, and electrolyte film 406 generally extend over most of the length of support tube 402.

The present invention further provides an anode-supported tubular fuel cell stack with easy to fabricate and low-cost metal sheet interconnects. The metal sheet interconnects are oxidation resistant at high temperature, flexible to accommodate thermal expansion stress to provide strong electrical contact, low electrical resistance design, inexpensive and lightweight. The metal sheet interconnects are formed to provide a resilience (or a “spring-like” quality) to allow good electrical contact between tubular cells and, at the same time, releases thermal stresses and improves shock or vibration resistance of the cell stack. The resilient electrical contacts can take various forms, including bent sheet metal strips, folded sheet metal, and curved sheet metal.

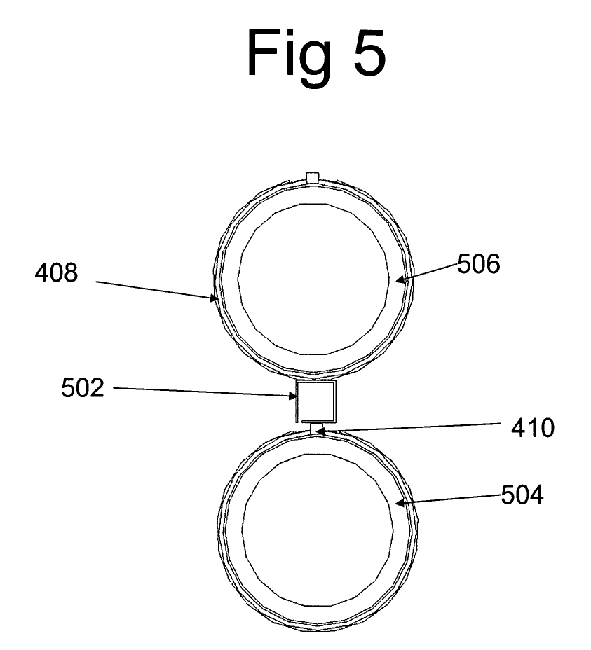

FIG. 5 shows a cross-section view of a folded sheet metal interconnect element 502 connecting two tubular fuel cells 504 and 506, in accordance with one embodiment of the present invention. Interconnect element 502 may be formed out of a sheet of a high temperature oxidation resistant alloy. As shown in FIG. 5, interconnect element 502 physically contacts interconnect stripe 410 of tubular cell 504 and the outer surface of tubular cell 506, thereby forming an electrical connection between the anode of tubular cell 504 and cathode 408 of adjacent tubular cell 506. Thus, tubular fuel cells 504 and 506 are connected in series over the length of the tubular cells. The sheet can be shaped to form an elongated bar with a square cross section, as shown in FIG. 5.

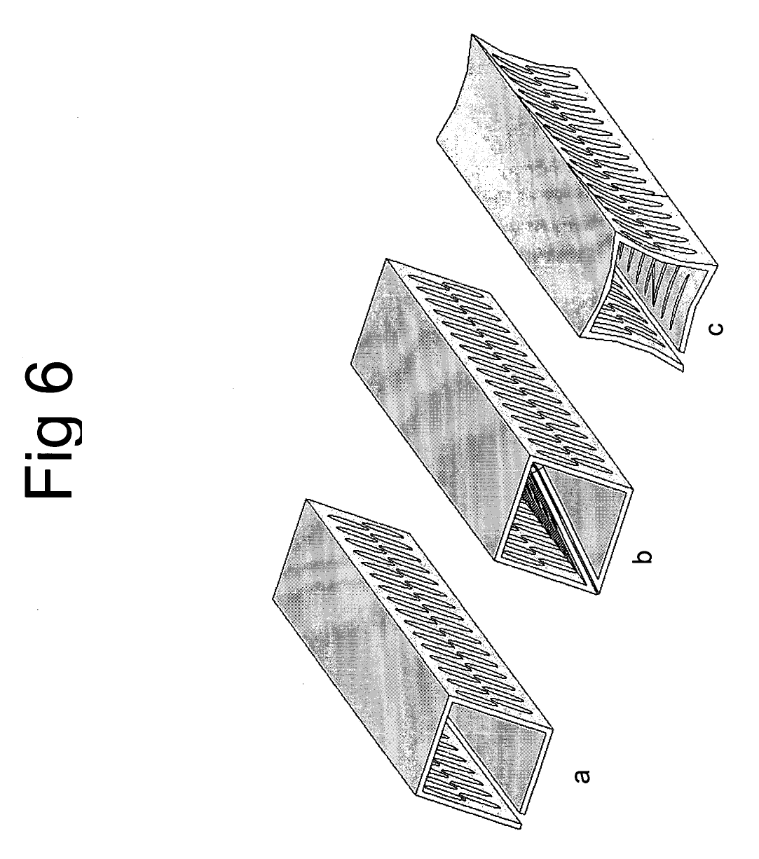

FIG. 6a, b, and c show metal sheet interconnect elements 601, 602 and 603, respectively, each formed out of folding a metal sheet, which can be used as interconnect element 502 of FIG. 5, in accordance with embodiments of the present invention. Interconnect elements 601, 602 and 603 may each be formed by folding a metal sheet into a hollow bar with a square or rectangular cross section. Interconnect element 601 of FIG. 6a may be formed by folding a sheet metal in 4, and interconnect element 602 of FIG. 6b may be formed by folding the sheet metal in 5 or more sides, with one or more sides overlapping along the diagonal of the square or rectangular cross section to provide better electrical contact with an interlocking mechanism. Further, as shown in interconnect element 603 of FIG. 6c, the sides of the interconnect element may be curved to allow a larger electrical contact area by conforming to the curved surface of the tubular cells. In addition, the curved sides of interconnect element 603 that are not in contact with the tubular cells provide a resilience or spring-like effect to achieve contact with the cells while, at the same time, acts as a shock absorber. The spring action of interconnect element 603 provides good electrical contact without generating excessive mechanical stress on the mostly ceramic tubes.

Interconnect element 601, 602 and 603 may each be formed out of a metal sheet that is preferably perforated, with holes placed at regularly spacing from each other, to provide good gas exchange. Perforation ensures high homogeneity in gas distribution through out the fuel cell stack. The number of holes per square inch of the sheet can vary substantially between 1 to 1000, preferably between 2 to 100 and more (more preferably between 5 to 50). The perforations can be of any shape, including circular, and square, rectangular and triangular. The thickness of the sheet metal for forming interconnect element 502 may be between 10 to 5000 microns (preferably between 20 to 1000 microns, and more preferably between 50 to 250 microns). Too thin a metal sheet may cause a large ohmic drop in the interconnect element because the current is not flowing across the plane of the metal sheet, but parallel to it. On the other hand, too thick a metal sheet results in the metal sheet not being sufficiently flexible to provide the resilience for releasing the mechanical stress. Many variations of interconnect element 502 are possible within the scope of the present invention.

Interconnect 502 may be made from a variety of high temperature oxidation resistant alloys, such as Inconnel 600, Hastelloy X, Haynes alloys, and stainless steels. The spring-like flexibility in interconnect element 502 eliminates the thermal expansion problem due to mismatch of expansion coefficents between the ceramic fuel cell and the metal interconnect, as discussed with respect to the planar fuel cells above. Also, unlike tubular cathode-supported fuel cell, an anode-supported fuel cell described herein exposes the metal sheet interconnect element only to the air environment, thus avoiding the corrosion and carburization problems associated with its exposure to the fuel gases (i.e., hydrogen, steam and hydrocarbon fuels). As a result, a wide range of metals can be used to form interconnect element 502. The metal sheet interconnect in the present invention also presents major cost advantages relative to the traditional nickel felt and nickel mesh of the prior art.

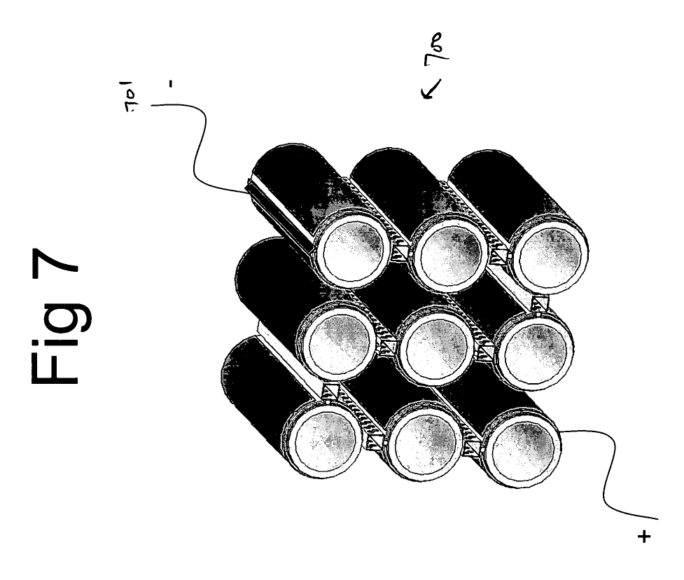

FIG. 7 shows tubular fuel cell stack 700 in which the cells are electrically connected in series using the metal sheet interconnects of the present invention. The metal sheet interconnects connect electrically the anode of one cell to the cathode of the next cell. At the end of the series may be placed the two high temperature resistance alloy bars (e.g., alloy bar 701), to provide positive and negative terminals to facilitate external connection. In this manner, a large range of currents and high voltages may be output from fuel cell stack 700.

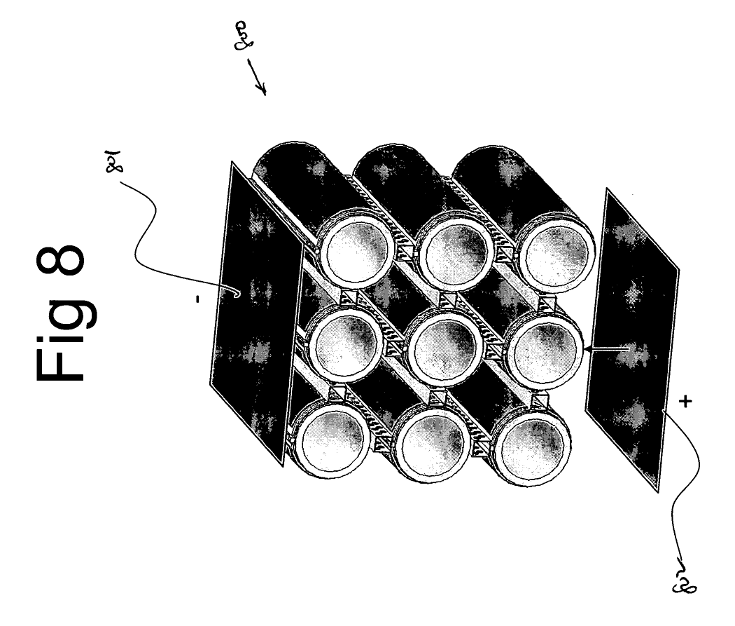

FIG. 8 shows tubular fuel cell stack 800, having metal sheets 801 and 802, and sheet metal interconnect elements that interconnect the fuel cells of fuel cell stack 800 both in series and in parallel, according to one embodiment of the present invention. Metal sheets 801 and 802, which form the positive and negative terminals of the fuel cell stack 800, provide parallel connections of the cathodes of the fuel cells in the top and bottom rows. Metal sheets 801 and 802 may be formed out of high temperature oxidation resistant alloy plates. With parallel connections, a single defective cell does not cause a connectivity failure in tubular fuel cell stack 800.

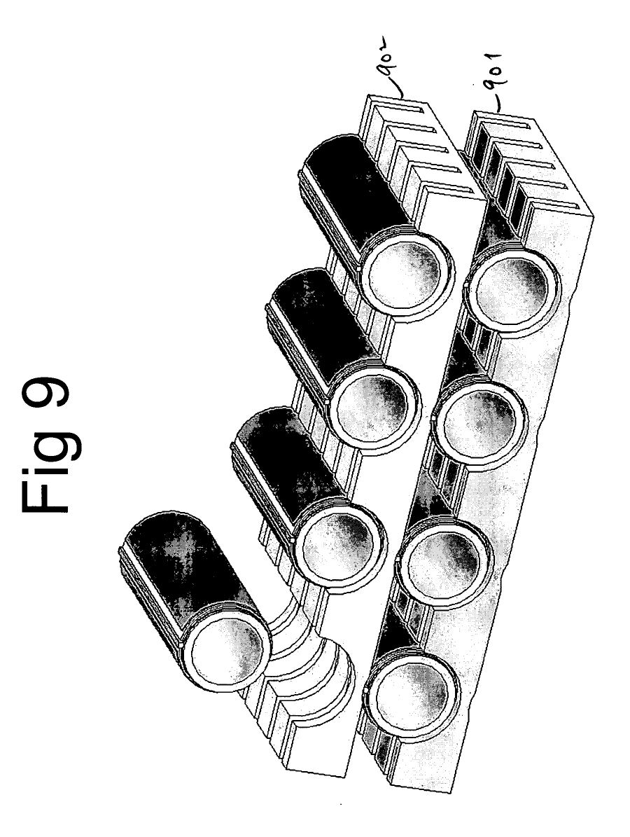

Using interconnect elements in the configuration of tubular fuel cell stack 800 is effective up to about 1000 tubular cells. The assembly of a large number of individual interconnect elements is both time and labor intensive, and thus may not be amenable to effective scaling up of the design to include a larger number of fuel cells. One alternative to individual interconnect elements is shown in FIG. 9. FIG. 9 shows interconnect structures 901 and 902, each formed in the shape of a metal bar and having semi-circular grooves to accommodate the tubular fuel cells and slits in the interconnect structure along a perpendicular direction to allow air passage. As shown in FIG. 9, the series and parallel electrical connections are being assured by contacts in two dimensions instead of only the direction along the length of the tubular cells, as shown in FIG. 8. The semi-circular grooves in the interconnect plates ensure good electrical contact while also providing a anchorage to minimize movements of the tubes. The slits define metal plates that can be perforated to provide regularly spaced holes to allow good gas homogeneity. The thickness of the plate where there is no contact to be made with the tubes may be made between 0.1 to 10 mm (more preferably between 0.5 to 5 mm). Suitable materials for interconnect structures 901 and 902, other than high temperature alloys, include ceramic materials, such as lanthanum chromite, or composite metal-ceramic.

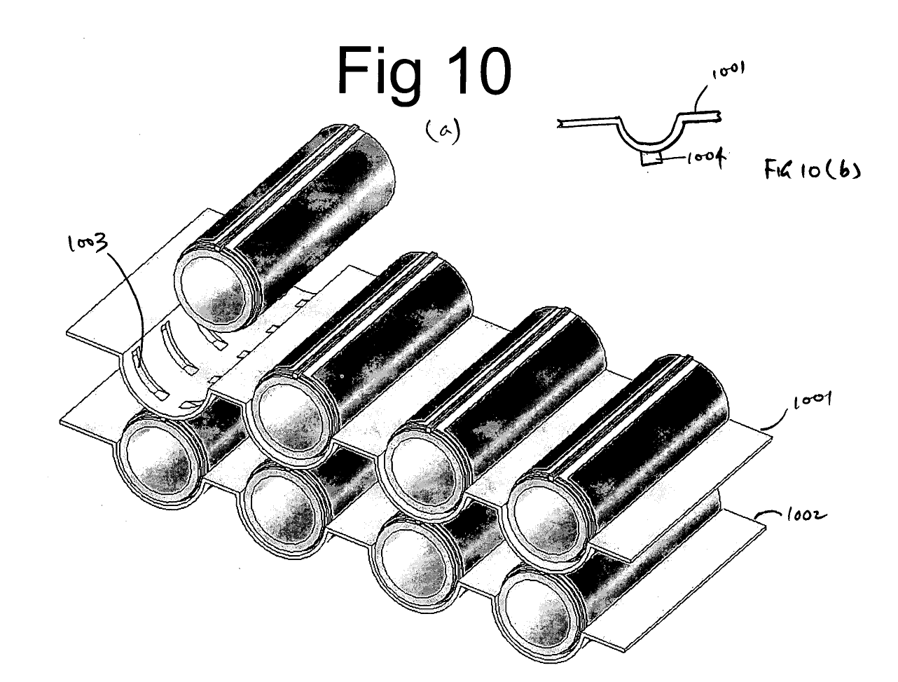

According to one embodiment of the present invention, FIG. 10(a) shows interconnect structures 1001 and 1002, which may be formed out of a high temperature oxidation resistant metal sheet. Structures 1001 and 1002 each include flat portions, which provide structural support, and semi-circular groove portions to hold the tubular cells in place. Interconnect structures 1001 and 1002 are provided with perforations 1003 for gas passage. As in interconnect structures 901 and 902, interconnect structures 1001 and 1002 provides maximum contact areas along two dimensions with the fuel cell electrodes. FIG. 10(b) shows interconnect structure 1001 in greater detail along a cross section. As shown in FIG. 10(b), to ensure that tubular cells connected in series are separated by a desirable separation, rectangular bar spacer 1004 may be provided between the bottom of the grooved portion of interconnect structure 1001.

(To facilitate the detailed description, interconnect structures shown in FIGS. 6-10 show equal tube sizes and contact areas. In practice, there is no restriction on the tube sizes and contact areas. A large surface area in contact with the cathode provides efficient current collection).

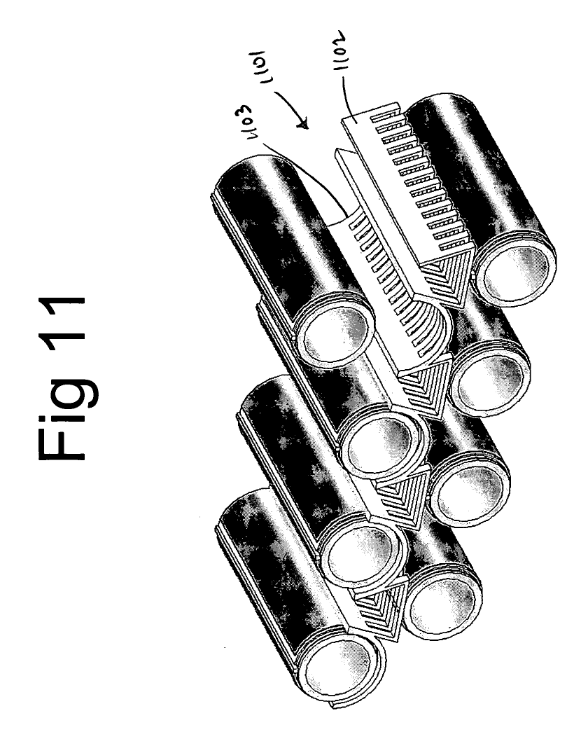

FIG. 11 shows metal sheet interconnect structures 1101 for a tubular fuel cell stack, according to another embodiment of the present invention. As shown in FIG. 11, interconnect structure 1101 is formed out of a single sheet metal to include bent portion 1102, which provides resilience or spring-like action to allow lateral movements of the tubular cells, and a curved portion 1103, which allows two-dimensional electrical connect with the cathodes of all the tubular cells in the upper row of the fuel cell stack. As shown in FIG. 11, bent portion 1102 electrically contacts an anode of the bottom row of the fuel cell stack. The particular curved shape, and “U” shape bent portion with inward tilting prongs of the “U”, and a flat bottom provide a natural and simple mechanism for interlocking the tubes. Interconnect structure 1101 is perforated to ensure gas homogeneity. As shown in FIG. 11, between two rows in the tubular fuel cell stack, the tubular cells are offset from each other.

With respect to the interconnect structures of FIGS. 7 to 10, a repetitive building block for the fuel stack cell is a square unit constituted by four tubular cells organized to have two cells connected in series and two cells connected in parallel. In the embodiment of FIG. 11, however, the basic building block includes 4 cells in a diamond unit, with the two cells in one row offset from the two cells in the other rows (i.e., the angle of the repetitive building block unit has an internal angle other than 90 degrees). All the tubes in the same row of the fuel cell stack are connected in parallel, while the tubes from adjacent rows are connected in series. A higher packing density may be achieved using interconnect structure 1101 over the interconnect structures of FIGS. 7 to 10.

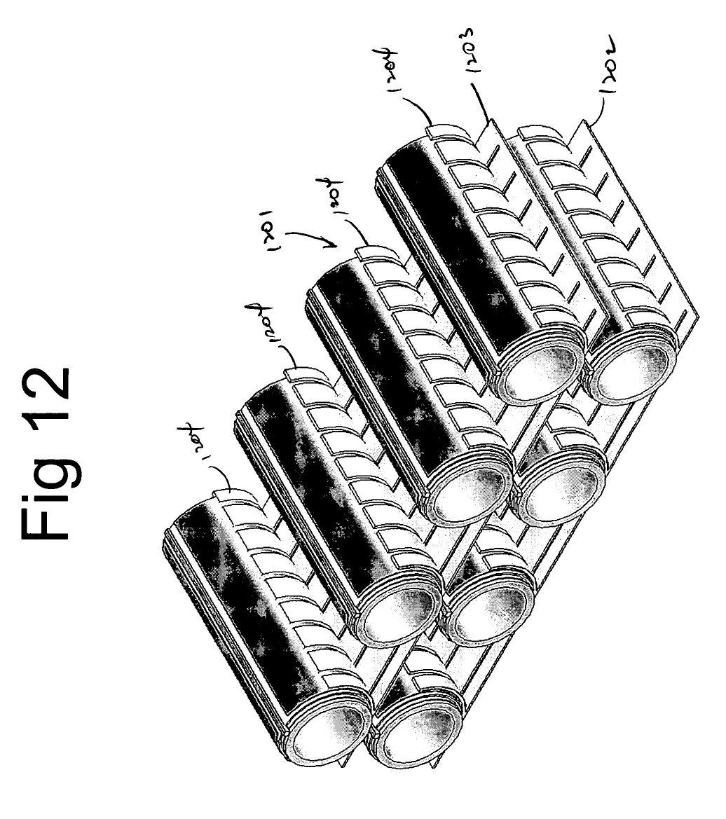

In accordance with another embodiment of the present invention, FIG. 12 shows interconnect structure 1201, which includes a flat portion 1203 and a number of curved portions 1204 each having curved fingers. Each of curved portions 1204 may be formed out of a sheet metal. Curved portions 1204 may be welded to flat portion 1203 at regular intervals. Flat portion 1203 provides structural support and defines the locations of the tubular cells in the fuel cell stack, and the curve fingers of each curved portion 1204 keep the corresponding tubular cell in place with two-dimensional contact to the electrodes of the cells. The space between the curved fingers and perforations in flat portion 1203 allow high degree of gas homogeneity. Flat portion 1203 may be made between 0.1 to 5 mm thick, while each of the curved fingers may be made 0.1 to 1 mm thick.

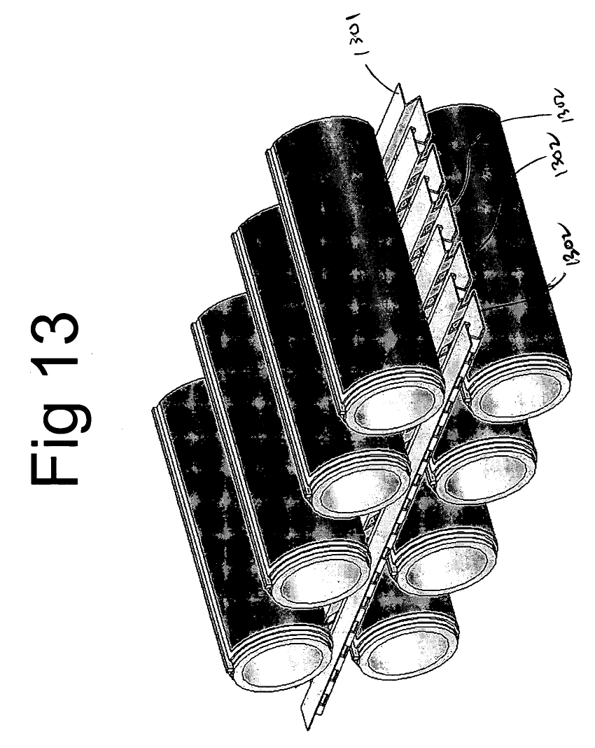

FIG. 13 shows interconnect structure 1301, in accordance with another embodiment of the present invention. As shown in FIG. 13, interconnect structure 1301 includes multiple “U” shape bent portions 1302 each having inward tilting prongs of the “U” shape, and a wide flat bottom. Structure 1302, which may formed out of lightweight sheet metal, thus provides resilience for vertical movements of the tubular cells (i.e., perpendicular to the tube axis) and to accommodate thermal expansion stress. Interconnect structure 1301 may be perforated to ensure gas homogeneity.

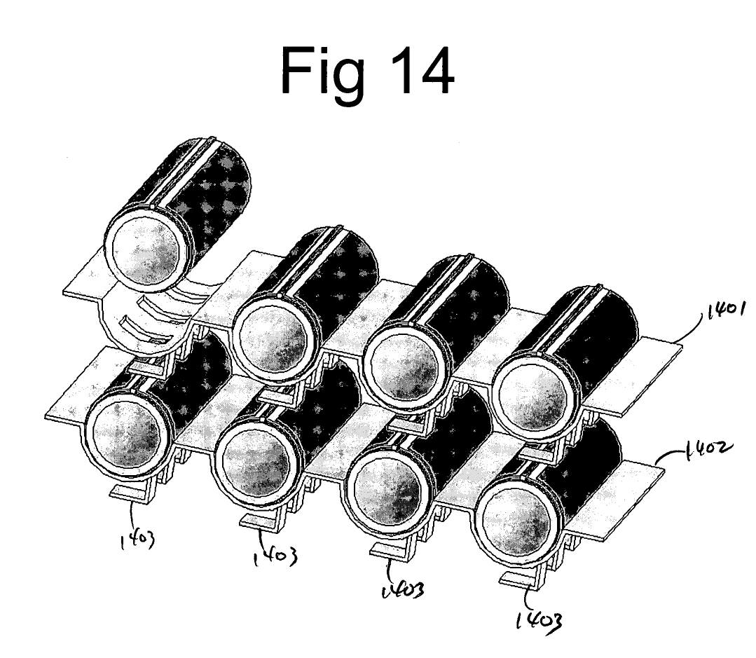

FIG. 14 shows interconnect structures 1401 and 1402, which may be formed out of a high temperature oxidation resistant metal sheet, similar to interconnect structures 1001 and 1002 of FIG. 10(a). As in interconnect structures 1001 and 1002 of FIG. 10(a), the flat portions provide structural support, and the semi-circular groove portions hold the tubular cells in place. Interconnect structures 1401 and 1402 are provided with perforations 1403 for gas passage. These perforations in each of interconnect structures 1401 and 1402 may be formed by stamping, with the stamped out sheet metal formed into bent fingers 1403 extending below the semi-circular groove portions. Bent fingers 1403 ensure that tubular cells connected in series are separated by a desirable separation, and provide resilience to allow vertical movements between the tubular fuel cells in adjacent rows of the fuel cell stack.

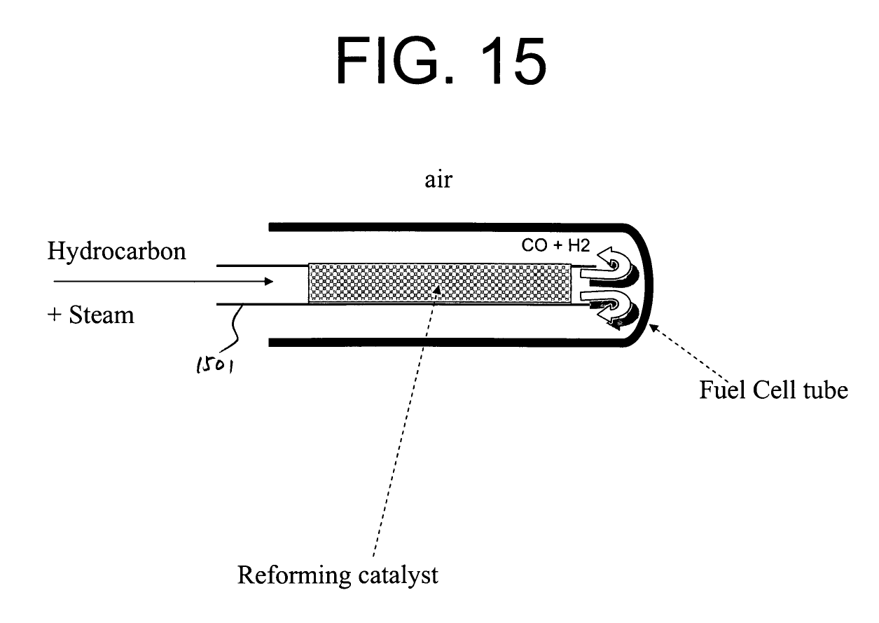

To deliver fuel gas to each fuel cell, the fuel can either be flown directly inside the fuel cell tubes or more preferably through a fuel delivery tube, especially for a closed one end tube design, as illustrated in FIG. 15. As shown in FIG. 15, fuel delivery tube 1501 may contain catalysts for reforming the hydrocarbon fuel (i.e., transforming the hydrocarbon fuel gas and steam into carbon monoxide and hydrogen gas, which are used in the electrochemical conversion reaction of the fuel cell). Using this arrangement, the heat generated in the electrochemical conversion process of the fuel cell, which must otherwise be removed, is used in the endothermic reaction of fuel reforming. Suitable hydrocarbon fuel gases include methane, natural gas or propane. This design enables efficient heat exchange between the reforming reaction inside the delivery tube and the electrochemical oxidation outside of it. Fuel delivery tube 1501 may be made from ceramic, or more preferably high temperature alloys for better heat transfer.

The detailed description above is provided to illustrate and not to limit the several embodiments of the present invention. Each embodiment may have a wide range of possible configurations, and variations, modification and adaptation of these embodiments for various applications may be readily accomplished by those skilled in the art upon consideration of the detailed description above. In addition to SOFCs, other electrochemical devices such as electrolyzers, oxygen pumps, oxygen generators and compressors may also take advantage of the present invention. Although the embodiments are in part described using anode-supported fuel cells, the present invention is also applicable cathode-supported fuel cell applications. The present invention is set forth in the accompanying claims.

1. A fuel cell stack, comprising
a plurality of tubular fuel cells each having an anode and a cathode, and contact surfaces for electrically connecting to the anode and the cathode, respectively; and
an interconnect structure formed out of sheet metal for contacting one or more of the contact surfaces of the fuel cells.

2. A fuel cell stack as in claim 1 wherein the tubular fuel cells each further comprise an electrically conductive support tube.

3. A fuel cell stack as in claim 1 wherein each tubular fuel cell has an outside diameter between 0.25 inch to 1 inch.

4. A fuel cell stack as in claim 1 wherein the tubular fuel cells each have an outside diameter between 0.25 inch to 0.75 inch.

5. A fuel cell stack as in claim 1 wherein the tubular fuel cells each have a wall thickness of 0.1 mm to 3 mm.

6. A fuel cell stack as in claim 1 wherein the tubular fuel cells each have a wall thickness of 0.5 mm to 2 mm.

7. A fuel cell stack as in claim 1 wherein the thickness of the electrolyte layer is between 1 to 50 microns.

8. A fuel cell stack as in claim 1 wherein the thickness of the electrolyte layer is between 5 to 30 microns.

9. A fuel cell stack as in claim 1 wherein the thickness of the outer electrode layer is between 10 to 70 microns.

10. A fuel cell stack as in claim 1 wherein the thickness of the outer electrode layer is between 20 to 50 microns.

11. A fuel cell stack as in claim 1 wherein the tubular fuel cells are anode-supported solid oxide fuel cells.

12. A fuel cell stack as in claim 11 wherein the thickness of the anode is between 20 to 100 microns thick.

13. A fuel cell stack as in claim 11 wherein the thickness of the anode is between 30 to 75 microns thick.

14. A fuel cell stack as in claim 1 wherein the interconnect structure is perforated.

15. A fuel cell stack as in claim 1 wherein the interconnect structure is perforated with a number of holes between 1 to 1000 per square inch.

16. A fuel cell stack as in claim 1 wherein the interconnect structure is perforated with a number of holes between 10 to 100 per square inch.

17. A fuel cell stack as in claim 1 wherein the interconnect structure is perforated with a number of holes between 20 to 50 per square inch.

18. A fuel cell stack as in claim 1 wherein the interconnect structure comprises a curved portion shaped to conform to the outer curved contour of a tubular fuel cell.

19. A fuel cell stack as in claim 18, wherein the curved portion is perforated.

20. A fuel cell stack as in claim 19, wherein a perforation of the curved portion is created by cutting the perforation from the sheet metal without complete severance, and wherein the material cut out to create the perforation is bent into a finger form adapted to contact one of the contact surfaces of a tubular fuel cell.

21. A fuel cell stack as claim 18, wherein the interconnect structure further comprises a flat portion.

22. A fuel cell stack as in claim 18, wherein the curved portion and the flat portion are formed out of a single piece of sheet metal.

23. A fuel cell stack as in claim 21, wherein the curved portion is attached to the flat portion by a process selected from the group consisting of welding and brazing.

24. A fuel cell stack as in claim 21, wherein the flat portion is perforated.

24. A fuel cell stack as in claim 18, wherein the curved portion comprises a plurality of fingers.

25. A fuel cell stack as in claim 21, wherein the flat portion is part of a bent portion formed by folding the sheet metal into a “U” shape, the flat portion being the bottom of the “U” shape.

26. A fuel cell stack as in claim 25, wherein the prongs of “U” shape is formed by opposing non-parallel walls of the sheet metal.

27. A fuel cell stack as in claim 26, wherein the opposing walls of the “U” shape tilts inwards.

28. A fuel cell stack as in claim 1 further comprising a solid conductive plate.

29. A fuel cell stack as in claim 1 wherein the interconnect structure contacts one or more of the contact surfaces of the tubular fuel cells at one or more designated positions, and a section between the designated positions bent in a predetermined shape for providing resilience.

30. A fuel cell stack as in claim 1, wherein the interconnect structure comprises a tubular structure with a rectangular cross section.

31. A fuel cell stack as in claim 30, wherein the tubular structure is formed by folding a sheet metal in 4.

32. A fuel cell stack as in claim 30, wherein the tubular structure is formed by folding a sheet metal in 5.

33. A fuel cell stack as in claim 30, wherein the tubular structure is formed by folding a sheet metal in 6.

34. A fuel cell stack as in claim 1, wherein the interconnect structure comprises a tubular structure with a 4-point star cross section and curved faces.

35. A fuel cell stack as in claim 34, wherein the tubular structure is formed by folding a sheet metal in 4.

36. A fuel cell stack as in claim 1, wherein the thickness of the sheet metal is between 10 to 5000 microns.

37. A fuel cell stack as in claim 1, wherein the thickness of the sheet metal is between 20 to 1000 microns.

38. A fuel cell stack as in claim 1 wherein the thickness of the sheet metal is between 50 to 250 microns.

39. A fuel cell stack as in claim 1 wherein the sheet metal is made of high temperature oxidation resistant alloys.

40. A fuel cell stack as in claim 1 wherein the sheet metal is made of high temperature oxidation resistant alloys selected from a group consisted of Inconnels, Hastelloys, Haynes, and stainless steel.

41. A fuel cell stack as in claim 25 wherein the bent portions are provided multiple times in the interconnect structure, so as to allow the bent portion to contact more than one fuel cell.

42. A fuel cell stack as in claim 2, wherein the anode is formed on the surface of the electrically conductive support tube.

43. A fuel cell stack as in claim 42, wherein an electrolyte layer is formed on the surface of the anode, covering the anode substantially except for a portion of the anode in the shape of a stripe running longitudinally along the length of the tubular fuel cell.

44. A fuel cell stack as in claim 43, wherein the cathode is formed on the surface of the electrolyte layer covering substantially the entire surface of the electrolyte layer.

45. A fuel cell stack as in claim 43, wherein a conductive material is provided over the anode along the stripe, so as to provide one of the contact surfaces.

46. A fuel cell stack as in claim 1, wherein the tubular fuel cells are arranged in aligned rows.

47. A fuel cell stack as in claim 1, wherein the tubular fuel cells are arranged in rows, and wherein adjacent rows are offset by a predetermined distance.
